(19) United States
(12) Patent Application Publication
(10) Pub. No.: US 2008/0004005 A1
(43) Pub. Date: Jan. 3, 2008

(54) Direct ATS Position Reporting

(75) Inventor: James Jensen, Satellite Beach, FL (US)

Correspondence Address: GRAY, PLANT, MOOTY, MOOTY & BENNETT, P.A., P.O. BOX 2906, MINNEAPOLIS, MN, 55402-0906, US

(73) Assignee: SATCOM DIRECT, INC., Satellite Beach, FL (US)

(21) Appl. No.: 11/764,918

(22) Filed: Jun. 19, 2007

Related U.S. Application Data
(60) Provisional application No. 60/814,759, filed on Jun. 19, 2006.

(51) Int. Cl. H04Q 7/20; H04B 7/185

(52) U.S. Cl. 455/431; 455/3.02; 455/427

(57) ABSTRACT

A method and system for reporting the position of an aircraft to Air Traffic Services. The method comprises the steps of assigning at least one system access communication number to an aircraft, configuring a call routing system to provide a selection menu comprised of a plurality of Air Traffic Services radio facilities, initiating a call by dialing the system access communication number using a communications service, selecting at least one number corresponding to the Air Traffic Services radio facility sought, and routing the call to personnel at the corresponding Air Traffic Services radio facility using a communications device. The position of an aircraft is reported to the facility during the call.

### REFERENCE TO RELATED APPLICATION

This application claims priority to U.S. Provisional Application No. 60/814,759, filed Jun. 19, 2007, the contents of which are incorporated herein by reference.

### FIELD OF THE INVENTION

The invention relates generally to satellite communication systems and methods and, more particularly, to systems and methods for providing Air Traffic Service (“ATS”) position reporting while an aircraft is in flight.

### BACKGROUND OF THE INVENTION

Pilots are required to provide Air Traffic Service position reporting while in-flight via aircraft high frequency (“HF”) communications facilities. At certain times, pilots experience difficulties completing their ATS position reports due to HF interference and HF propagation issues.

In recent decades, several types of satellites have been deployed into orbit around the earth to communicate with various aircraft. Some satellites reflect communications directed at the satellite. Many satellites carry repeaters, for receiving and retransmitting a received communication, and are used for communication. In recent years satellites have been placed in orbits synchronous with the earth's rotation, thereby providing continuous communications capability among almost all parts of the globe.

If a satellite is placed in synchronous orbit above the equator to revolve in the same direction of the earth's rotation and synchronized with the earth's rotation that satellite will continually remain above a fixed point on the surface of the earth. Many communications satellites have been placed in these synchronous orbits to cover different regions of the globe.

Generally, active communications satellites are orbiting repeaters with broadband characteristics. A signal from a ground station is intercepted by the satellite, converted to another frequency and retransmitted at a moderate power level to an end user receiver. This provides much better signal strength at the receiving end of the circuit, as compared with a signal that is merely reflected from a passive satellite. Active communications satellites are placed in synchronous orbits, making it possible to use them with fixed antennas, a moderate level of transmitter power, and at any time of the day or night. Synchronous satellites are used for television and radio broadcasting, communications, weather forecasting, and military operations. Today, telephone calls are routinely carried by synchronous satellites.

Further, a constellation of satellite systems is used to cover major regions of the globe to enable ground-to-aircraft (and aircraft-to-ground) communications via the satellite systems. One example of such a constellation is INMARSAT, which has four satellites that are located in geostationary orbits, each satellite generally covers a region of approximately one-fourth of the globe with a certain amount of overlap between regions. These satellites are referred to as AOR-W (Atlantic ocean region-west), AOR-E (Atlantic ocean region-east), IOR (Indian ocean region), and POR (Pacific Ocean Region).

INMARSAT satellites support various different types of services to the aeronautical market. These services are defined as AERO H, AERO H+, AERO I, Swift64, and AERO M. All these services are available to aeronautical users. The airborne satellite communication system provides aircraft with multiple digital voice, fax, and real-time Internet communications capabilities. The system is specifically adapted for use in global two-way, ground-to-air communications by aircraft operators requiring global voice, fax, and Internet communications for their flight crews and passengers.

Similarly, the AERO I system provides aircraft with multiple digital voice, fax and real-time communications capabilities. This service is tailored to meet the communication needs of short/medium haul aircraft operators requiring voice, fax and data communications for the flight crew and passengers. AERO I spot beam service is available within each INMARSAT satellite region around the world. Each region contains several spot beams and users must be illuminated by a spot beam for an AERO I system to operate. Not all satellite regions have complete spot beam coverage and, based on the geographic location of an aircraft, users may not be able to use their AERO I system all of the time.

The INMARSAT AERO H+ system provides aircraft the option to use AERO H or AERO I based on the geographic location of the aircraft. To take advantage of this option, the aeronautical communication system must be able to support both AERO H and AERO I.

Another satellite system available for communications is the IRIDIUM satellite system, which delivers communications services to remote land, ocean, polar, and air regions through a constellation of sixty-six low-earth orbiting (LEO) satellites. IRIDIUM telephones and handsets communicate with the IRIDIUM network to send and receive voice and data communications.

Prior art systems have utilized direct ground-to-air calling systems, which provide communications between aircraft and Ground Earth Stations (GES). Generally, customers are provided with a calling card with instructions on how to call their aircraft.

For example, a typical caller trying to communicate with an aircraft based on three-quarters of the world coverage may have to dial several numbers, wait for a voice prompt, enter a PIN, enter the satellite area code, and then enter the aircraft number and terminal location. This process requires dialing over thirty-one sequential numbers in addition to waiting for voice confirmation. Similarly, a communication based on one-fourth of the world coverage requires entering/dialing twenty-seven numbers. The dialing complexity involving such a large number of sequential numbers has greatly deterred use of such ground-to-air communications for contacting an aircraft.

Further, prior art systems that use synchronous satellite systems, such as the INMARSAT, for inbound and outbound telephone calls from a ground station to aircraft require the input of a number of variables to make the calls. In addition to the need to dial several access numbers, callers must know the location of the aircraft, the satellite area code to which the aircraft is logged on to, the aircraft number, the aircraft terminal number, international access code for the specific global position of the aircraft and identification of the long distance provider may be required because not all long distance service providers may recognize the satellite area codes. Furthermore, if the aircraft is located in the AOR-E or IOR regions a call may not be made from North America. This is because the major long distance carriers, such as AT&T, MCI, and SPRINT, use TELENOR or another INMARSAT wholesaler for such communications.

Accordingly, prior art direct call systems are unreliable and cumbersome at best. Further, within each satellite region there are a number of GES, which are owned and operated by different entities and each GES provides different types of aeronautical services. For example, some GES operators support fax, while others may not offer such service. Similarly, not all GES operators support PC data, secure voice management, DID (direct in dial) and AESID (Aircraft Earth Station Identifier). Thus, some GES may support multiple numbers assigned/allocated for various services, while others have only very few numbers available to support a broad range of communication services.

### SUMMARY OF THE INVENTION

The invention solves many of the problems of pilots who have a difficult time completing their Air Traffic Service position reports due to high-frequency interference. With HF propagation and interference issues, oceanic position reporting can be tedious, cumbersome and challenging when reporting ATS position by HF. The present invention offers an option that is more reliable and dependable than HF communications systems by enabling pilots to use their assigned ground to air 10-digit number for global ATS position reporting.

The invention also solves many of the problems associated with communicating with multiple aircraft or other mobile vessels or crafts for voice and data exchanges. Various embodiments of the invention disclosed and described herein are directed to methods and systems for establishing communications with various modes of transportation, including a spacecraft, aircraft, vessel, and with various other communications devices that are on-board or that can be connected via short distance radio frequency or Bluetooth communications schemes.

In one example embodiment, the system and method of the invention provide connectivity to multiple aircrafts or other modes of transportation via a single ten-digit number. The initial call can be to a direct universal or assigned number, or the call can be forwarded or routed to the direct universal number via a toll-free access number. A caller is next prompted to select from an automated selection of aircraft or other mobile crafts, identified by tail number or other identifying means.

Based upon the selection, the system connects the caller to the single universal number for that selection. Callers then hear a greeting that identifies the aircraft selected and provides the handset, data service, or other options available for that aircraft. For example, the caller may be able to place a voice call to the flight deck of the aircraft or to one of a plurality of available cabin handsets, or send a fax or transmit other data communication.

In another embodiment, the system and method of the invention provide connectivity to multiple mobile communication devices via a single ten-digit number. The number can be the direct universal or assigned number or a toll-free number that forwards the call to the applicable universal number. A caller is next promoted to select a desired contact from an automated list of choices, for example an aircraft satellite communication system, an IRIDIUM handset, a maritime vessel, or a cellular telephone. Based upon the caller's selection, the system connects the caller to the single universal number for that selection. The caller then hears a greeting that identifies the selected device and provides any additional handset, data service, or other options available for that device.

One advantage of the system and method of the invention is that voice or data access to a plurality of aircraft or vessels can be achieved via a single ten-digit telephone number. Another advantage of the invention is that a plurality of communication devices having the same or varying communication systems can be accessed via a single ten-digit telephone number.

The invention includes a method for reporting the position of an aircraft to Air Traffic Services. The method comprises the steps of assigning at least one system access communication number to an aircraft. A call routing system is configured to provide a selection menu comprised of a plurality of Air Traffic Services radio facilities. A call is then initiated by dialing the system access communication number using a communications service. Next, at least one number is selected that corresponds to the Air Traffic Services radio facility sought. The call is then routed to personnel at the corresponding Air Traffic Services radio facility using a communications device. The position of an aircraft is reported to the facility during the call.

In an alternative embodiment, the invention includes a communication system for reporting the position of an aircraft to Air Traffic Services. The system includes a means for assigning at least one system access communication number to an aircraft, a means for configuring a call routing system to provide a selection menu comprised of a plurality of Air Traffic Services radio facilities, a means for initiating a call by dialing the system access number. The system further includes a means for selecting at least one number corresponding to the Air Traffic Services radio facility sought and means for routing the call of personnel at the corresponding Air Traffic Services facility.

The above summary of the invention disclosed herein is not intended to describe each illustrated embodiment or every implementation of the invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a flowchart of a method of reporting ATS position according to one embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

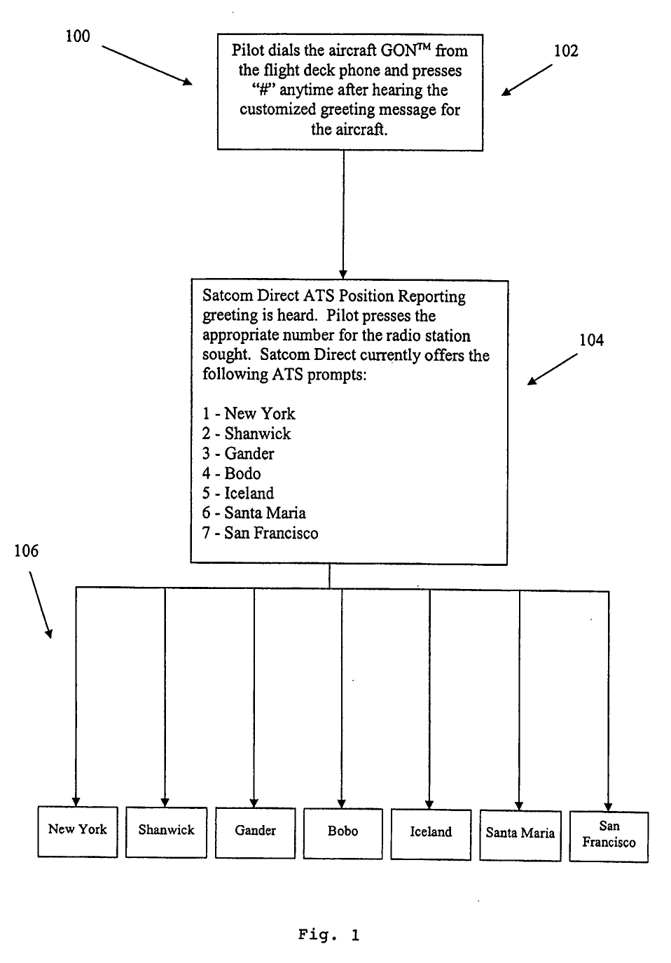

The call routing method and system disclosed herein provides pilots the option to use their satellite communication systems to report the position of their aircraft to the ATS. Each aircraft has a simple 10-digit number that can be used by pilots for global ATS position reporting. The invention can be more readily understood by reference to FIG. 1 and the following description. While the invention is not necessarily limited to such an application, the invention will be better appreciated using a discussion of example embodiments in such a specific context.

One recent global calling system that enables ground stations to call an aircraft anywhere within INMARSAT and similar communication satellite systems, as previously described, by using only one simple phone number without the necessity for human intervention, is disclosed in U.S. Pat. No. ______, which is commonly assigned with the present application and is incorporated herein by reference. The system disclosed in U.S. Patent Application Publication No. 2002/0111165 is fully automatic and solid state and provides a ground-to-air communications system with comprehensive features to enable real-time and efficient communications between aircraft, vessels, and multiple ground earth stations on a global coverage basis.

FIG. 1 comprises a flowchart of one embodiment of the system and method of the invention. Throughout this application, the term “call” will be used to refer to any of a telephone call, data call, or other communications connection from, with, or between telephones, computers, systems, or other devices. For example, “devices” can encompass and include communication devices, data gathering or generating devices, audio and video equipment devices, lighting and alarm equipment devices, and any and all other devices that can be accessed locally or remotely for activation, communication, deactivation, and/or other action, as will be understood by those skilled in the art in the context of the embodiments described herein.

With reference to FIG. 1, according to one embodiment of the ATS position reporting system and method 100, a call is initiated by a caller dialing an access number assigned to the aircraft. For example, in a preferred embodiment, the access number is a toll-free ten-digit telephone number, for example a number beginning with 800 or 888, although the access number can be assigned any available telephone number. The number is preferably a ten-digit number for simplicity and user familiarity.

The ten-digit number can be printed on a wallet-sized card that is presented to the caller and can be conveniently carried by the caller at all times. A quick reference to the number on the card prepares the caller for establishing communication with an ATS radio facility over any convenient communication system. In one embodiment, however, initiating communication with the ten-digit number is as simple as dialing a long-distance call.

Subsequently, at steps 102 the pilot presses “#” anytime after hearing the customized greeting message for the aircraft. Next, at 104, the position reporting greeting is heard and the pilot presses the appropriate number of the ATS radio station facility that is sought 106. For example, exemplarily menu options include the following: 1—New York, 2—Shanwick, 3—Gander, 4—Bodo, 5—Iceland, 6—Santa Maria, 7—San Francisco. After pressing the number for the ATS radio station facility that is sought, the pilot is connected to personnel at that ATS radio station facility.

Although this example uses particular ATS prompts and devices for purposes of illustration of the invention, other prompts, devices, and combinations of prompts and devices can be used without departing from the spirit and scope of the invention. The available selections are preferably provided to the caller as an automated voice menu in which the caller can make a desired selection by pressing a corresponding number on their telephone handset. In one embodiment, the automated voice menu is hosted by an operations center that manages and monitors the system.

After a selection has been made, the system routes the caller to the selected ATS station. The ATS position may be reported automatically through electronic means, or verbally while remaining within the spirit of the invention. If additional options are available for the selection, the options are then presented to the caller for selection via a similar automated voice menu.

In another example embodiment, the call routing system of the invention is accessible by a variety of modern communications devices. In addition to landline, cellular, and satellite and other advanced communication technology telephones, the call routing system and method can also be used as a communications interface to route calls and communications, and establish connectivity, between personal computers, computer networks, handheld computer devices and personal digital assistants (“PDAs”), two-way pagers, and other voice and data devices, and mobile vessels and crafts. In this embodiment, the computer or other device can contact and connect with the call routing system via plain old telephone service (“POTS”) where appropriate for line and/or modem equipped devices.

Other devices can connect using wired or wireless, stand-alone or networked, Internet connections and communications protocols, including voice over internet protocol (“VOIP”). Additionally, devices can also connect to the call routing system via a cellular service provider, although some providers may require particular account types or permissions in order to access particular numbers, for example a Universal Number (“UN”) having a country code different from a cellular service subscriber's account telephone number country code.

The system and method of the invention thereby provide a user-friendly and convenient way of completing ATS position reports by establishing communications with a plurality of global satellite communications systems, regardless of a particular aircraft's surface or air location. The system and method further provide connectivity via multiple communications and satellite systems, technologies and formats, all accessible by a single access number.

The invention as depicted and described herein may be embodied in other specific forms without departing from the spirit or essential attributes thereof, and it is, therefore, desired that the embodiments be considered in all respects as illustrative and not restrictive. Similarly, the above-described methods are illustrative sequential processes and are not intended to limit the methods of the invention to those specifically defined herein.

It is envisioned that various depicted steps can be performed in differing substantive and sequential order. In addition, various unspecified steps and procedures can be performed in between those steps described herein without deviating from the spirit and scope of the invention. Reference should be made to the appended claims rather than to the foregoing description to indicate the scope of the invention.

1. A method of reporting the position of an aircraft to Air Traffic Services, the method comprising:
assigning at least one system access communication number to an aircraft;
configuring a call routing system to provide a selection menu comprised of a plurality of Air Traffic Services radio facilities;
initiating a call by dialing the system access communication number using a communications service;
selecting at least one number corresponding to the Air Traffic Services radio facility sought; and
routing the call to personnel at the corresponding Air Traffic Services radio facility using a communications device, wherein the position of an aircraft is reported to the facility during the call.

2. The method of claim 1, wherein the system access number consists essentially of ten digits.

3. The method of claim 2, wherein the system access number comprises a three-digit area code and a seven-digit number assigned to the plurality of available vehicles.

4. The method of claim 3, wherein the three-digit area code is a toll-free number designator.

5. The method of claim 1, and further comprising the step of providing an automated voice prompt menu to the aircraft.

6. The method of claim 5, wherein the step of selecting the at least one number corresponding to the Air Traffic Services radio facility sought comprises entering a corresponding number on a telephone keypad.

7. The method of claim 1, wherein the plurality of Air Traffic Services radio facilities are stored in a searchable database.

8. The method of claim 7, wherein the plurality of Air Traffic Services radio facilities are selected from the group consisting essentially of New York, Shanwick, Gander, Bodo, Iceland, Santa Maria, and San Francisco.

9. The method of claim 1, wherein the available system access communication numbers are stored in a searchable database.

10. The method of claim 1, and further comprising the step of pressing the “#” key to prompt a menu of Air Traffic Services radio facilities.

11. The method of claim 1, and further comprising the step of verifying the call by searching a subscriber database for subscriber account information and associated account services.

12. The method of claim 11, and further comprising the step of broadcasting a pre-recorded instructional message.

13. The method of claim 1, wherein the communications service includes the INMARSAT satellite system.

14. The method of claim 1, wherein the communications services includes the IRIDIUM satellite system.

15. The method of claim 1, wherein the communications device is selected from the group consisting of a land-line based telephone, a facsimile machine, a personal computer, a personal digital assistant (PDA), a cellular telephone, a pager, and a Bluetooth based device.

16. The method of claim 1, wherein the menu comprised of a plurality of Air Traffic Services radio facilities is maintained by a communications operations center.

17. A method of reporting the position of an aircraft to Air Traffic Services using a satellite communication system, the method comprising:
configuring a call routing system to provide a selection menu comprised of a plurality of Air Traffic Services radio facilities:
initiating a call by dialing the system access communication number using a satellite communication system;
selecting at least one number corresponding to the Air Traffic Services radio facility sought; and
routing the call to personnel at the corresponding Air Traffic Services radio facility, wherein the position of an aircraft is reported to the facility.

18. The method of claim 17, wherein the system access number consists of ten digits.

19. The method of claim 18, wherein the satellite communication system is selected from the group consisting of the INMARSAT system and the IRIDIUM system.

20. A communication system for reporting the position of an aircraft to Air Traffic Services, the system comprising:
means for assigning at least one system access communication number to an aircraft;
means for configuring a call routing system to provide a selection menu comprised of a plurality of Air Traffic Services radio facilities;
means for initiating a call by dialing the system access number;
means for selecting at least one number corresponding to the Air Traffic Services radio facility sought; and
means for routing the call of personnel at the corresponding Air Traffic Services facility.
